(19) United States
(12) Patent Application Publication
(10) Pub. No.: US 2007/0188037 A1
(43) Pub. Date: Aug. 16, 2007

(54) An add-on kit comprising a ring of magnets installed onto a bicycle/car wheel; electromagnets installed onto a bike fork or car suspension which then provide assisted rotation.

(76) Inventor: Shing Lung Lau, San Francisco, CA (US)

Correspondence Address: SHING LUNG LAU, 453 31st ave, APT#2, SAN FRANCISCO, CA, 94121, US

(21) Appl. No.: 11/307,625

(22) Filed: Feb. 15, 2006

(51) Int. Cl. B62J 6/12; H02K 7/10; H02K 7/18

(52) U.S. Cl. 310/152; 310/67 A

(57) ABSTRACT

An add-on kit comprising a (1) ring of (2) magnets (easy to install) is installed onto a (6) wheel of bike or car. An arrangement of (3) electromagnets and (5) inductors (detectors) is installed onto the (4) fork of a bike or suspension of car in the proximity of the ring. By turning the (3) electromagnets on and off and controlling the on-time and the field strength, a force that assists the wheel in rotating is produced. With the electromagnets turned-off, the moving ring of permanent magnets also provides for regenerative braking. With the bicycle mounted on an elevated stand, and the controlled timing of the electromagnets programmed to induce a force in the backwards direction, a user can use his bike as an exercise machine, gaming/training apparatus, or just to recharge the batteries.

### DESCRIPTION

Intro

Right now, whether it is a motorized bike or a hybrid electrical car, they still use a motor which rotates about a grounded reference frame (i.e. the bike/car frame); a simpler and lighter method exists, since the wheel itself is a rotating entity. The method is similar to how a maglev train generates translational motion; only in this case, it is used to generate rotational motion.

Concept

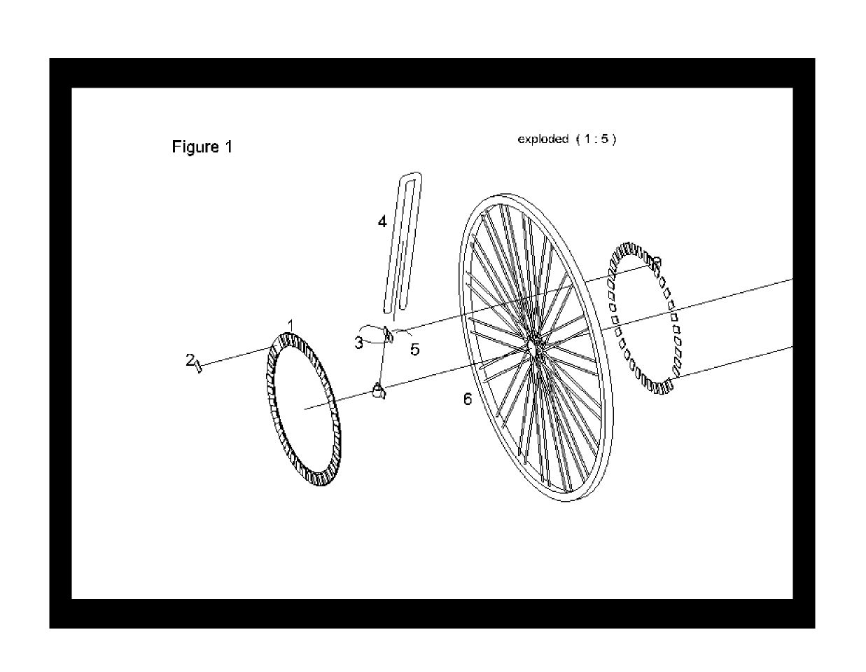

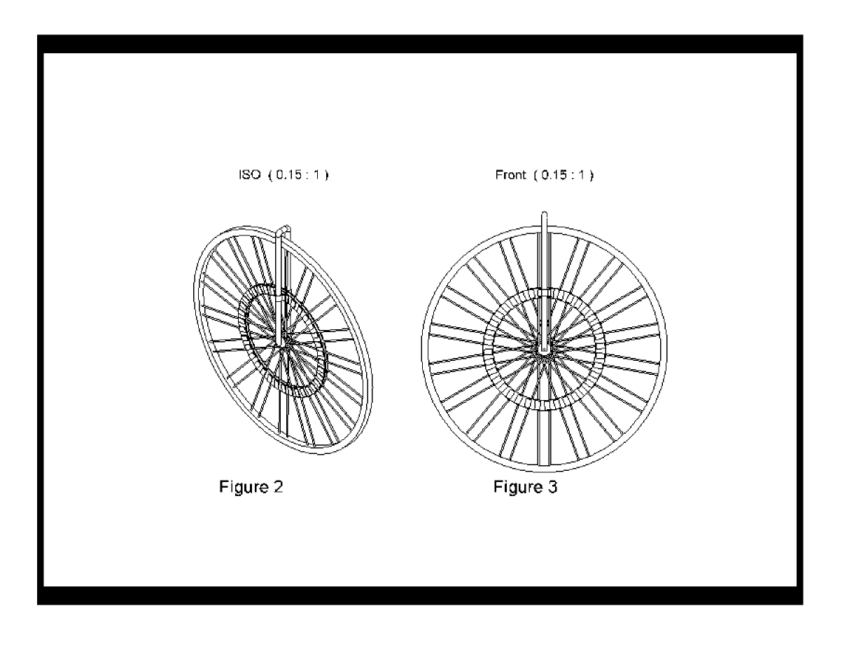

The method comprises of a simple (FIG. 1) (1) ring of permanent (2) magnets (alternate with north and south poles showing) installed onto a bicycle or car wheel and several (3) electromagnets installed onto the (4) fork/suspension of the bike/car. The (3) electromagnets are such that they can switch their orientation of magnetic fields at the right moment to either repulse or attract the nearby permanent magnets installed onto the (6) wheel, thereby generating rotational motion.

A (5) detector, either infrared or something simpler, i.e. a simple inductor (5) can tell a microcontroller when to switch the electromagnets on or off and in what orientation.

### MANUFACTURING AND MATERIALS

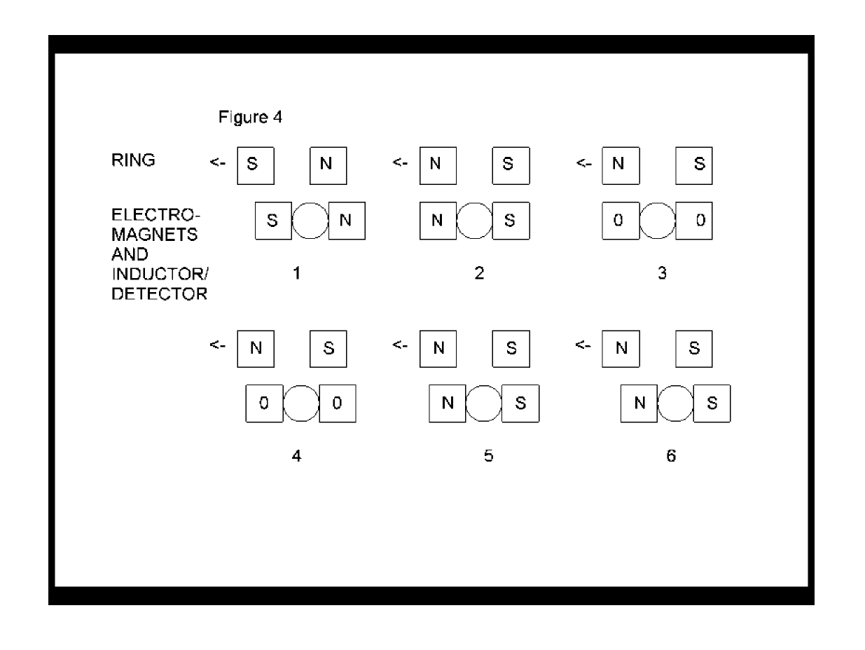

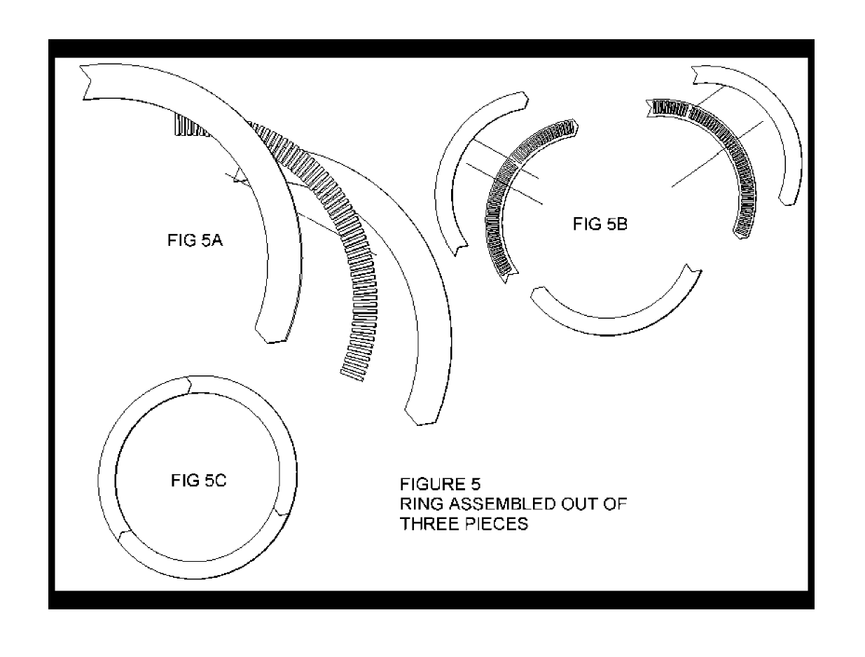

The ring will compose of a (FIG. 5) plastic base and a plastic cover with which cool reflective stickers can be place on, permanent magnets will be placed inside the ring. A magnet with its north pole facing outward will have neighbors with their south poles facing outward. There will be movable plastic hooks or metal clasps on the underside of the ring base to grip the spokes of a bicycle wheel with. There will be holes for screws for the ring to be installed onto the wheel of a car.

### USAGE EXAMPLE

If installed onto a bicycle, the microcontroller and power source should be powered off of widely available rechargeable batteries so as to make it easy to replace. The microcontroller should also allow the electrical energy generated during regenerative braking to be either fed back into the batteries (or super-capacitors) and be used to power front and rear LED bike lights.

System is very lightweight, robust, and low cost.

What is claimed is:

1. The system comprises of a (1) ring of magnets that is easy to install onto wheels, 3) Electromagnets and (5) sensors easily installs onto a vehicle (bike, car) via a clasp on the (4) fork or the suspension or frame, and a controller and power source (rechargeable batteries).

2. (By switching the (3) electromagnets of claim 1 at the right moments, rotational movement of the wheels is obtained, assisted, or opposed.

3. By switching the electromagnets of claim 1 to oppose the rotation of the wheels, a bike mounted on a stand with the wheels free to rotate can be used as an exercise or gaming device (when connected to a computer with appropriate software via the microcontroller).

4. The (3) electromagnets of claim 1 can be flipped to a position far away from the permanent magnets to essentially void all effects.

5. Individual (FIG. 1) (2) magnets on the ring of magnets of claim 1 need not be exposed and can be hidden with a cover so as to not make the bike ugly.

6. One to four rings of magnets of claim 1 can be installed on a single bicycle but still be controlled by only one microcontroller.

7. Controller of claim 1 can be configured to use automotive battery power source if system is installed on a car.

8. Even if the power source of claim 1 is such that the rotational force cannot move the vehicle alone, the magnetic forces can still be used to assist the bicyclist/car during acceleration.

9. (FIG. 1) (3) Electromagnets of claim 1 can be made to be switched on only when accelerator grip is pressed or can be made to be always on.

10. Changing the voltage level and on-time via the controller of claim 1 , the level of force assistance can be set to desired level.

11. Circuits in the controller of claim 1 allow for feedback of electrical power generated when voltage is not applied to the electromagnets. The electrical power is generated by the motion of permanent magnets across the powered-off electromagnets and inductors. Thus allowing for the recharging of batteries. Holding a bike aloft by hand and spinning the pedals will also recharge the batteries.

12. The ring of magnets of claim 1 shall be breakable into (FIG. 5) 3 to 4 pieces for easy transportation and storage.

13. Users can use their bikes as is; without removing a wheel to install a wheel hub motor for instance. And the whole kit comprising of the ring of magnets, electromagnets, controller with rechargeable AA batteries can be uninstalled without damage to bicycle. Kit is an add-on, which means that it does not have to be integrated into existing designs; this kit can be (easily) installed onto the wheels (rim of wheels) of an old diesel truck for instance and provide additional torque and stopping power in additional to power regeneration at braking. Kit can be installed onto most bikes and cars. Normal brakes already on bike or car is not affected by the ring of magnets and can be used in conjunction with regen braking. System can be made to not interfere with mechanical braking systems including disc brakes and caliper brakes.
